(19) United States
(12) Patent Application Publication
(10) Pub. No.: US 2019/0116468 A1
(43) Pub. Date: Apr. 18, 2019

(54) EFFICIENT BROADCAST TO MOBILE DEVICE OPERATING INDEPENDENTLY OF A SIM

(71) Applicant: NOKIA SOLUTIONS AND NETWORKS OY, Espo (FI)

(72) Inventors: Zexian Li, Espoo (FI); Rauno Tapani Ruismaki, Helsinki (FI); Mikko Aleksi Uusitalo, Helsinki (FI); Athul Prasad, Helsinki (FI)

(21) Appl. No.: 16/091,047

(22) PCT Filed: Apr. 4, 2016
(86) PCT No.: PCT/EP2016/057300

§ 371 Date: Oct. 3, 2018

(51) Int. Cl. H04W 4/06; H04W 48/10; H04L 29/08; H04W 4/60; H04W 76/40; H04W 72/00; H04W 64/00

(52) U.S. Cl. CPC H04W 4/06; H04W 48/10; H04L 67/24; H04W 64/003; H04W 76/40; H04W 72/005; H04W 4/60

(57) ABSTRACT

There is provided a method comprising providing, from a user device operating independently of a subscriber identity module, presence information to a network node using a first resource such that the network node is aware of the presence of the user device, wherein the presence information comprises a request for broadcast content and receiving broadcast content from the network node in response to providing the presence information.

### FIELD

The present application relates to a method, apparatus, system and computer program and in particular but not exclusively to an efficient broadcast scheme towards UEs without SIM to meet regulation requirements.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP).

### SUMMARY

In a first aspect, there is provided a method comprising providing, from a user device operating independently of a subscriber identity module, presence information to a network node using a first resource such that the network node is aware of the presence of the user device, wherein the presence information comprises a request for broadcast content and receiving broadcast content from the network node in response to providing the presence information.

The method may comprise receiving a broadcast of an indication of the first resource from the network node.

The method may comprise receiving the broadcast content using evolved multicast broadcast multimedia service.

The method may comprise determining a geographical location of the user device and determining to provide presence information using the first resource in dependence on the determined geographical location.

The method may comprise providing presence information using the first resource periodically.

The method may comprise receiving an indication of a resource on which broadcast information is to be received.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a second aspect, there is provided a method comprising receiving presence information from a user device operating independently of a subscriber identity module using a first resource such that the network node is aware of the presence of the user device, wherein the presence information comprises a request for broadcast content and providing broadcast content to the user device in response to receiving the presence information.

The method may comprise providing an indication of the first resource to the user device.

The method may comprise providing the broadcast content using evolved multicast broadcast multimedia service.

The method may comprise receiving presence information using the first resource periodically.

The method may comprise determining if presence information has been received in a first time period, and if so, providing broadcast content to the user device and, if not, causing the providing of broadcast content to stop or releasing a resource used for broadcast content.

The method may comprise providing an indication of a resource on which broadcast information is to be received in response to receiving the presence information.

The first resource may comprise at least one of a temporal resource, a code resource and a frequency resource.

The first resource may comprise a code resource and the presence information may comprise at least one preamble sequence reserved from a plurality of preamble sequence.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a third aspect, there is provided an apparatus, said apparatus comprising means for providing, from a user device operating independently of a subscriber identity module, presence information to a network node using a first resource such that the network node is aware of the presence of the user device, wherein the presence information comprises a request for broadcast content and means for receiving broadcast content from the network node in response to providing the presence information.

The apparatus may comprise means for receiving a broadcast of an indication of the first resource from the network node.

The apparatus may comprise means for receiving the broadcast content using evolved multicast broadcast multimedia service.

The apparatus may comprise means for determining a geographical location of the user device and means for determining to provide presence information using the first resource in dependence on the determined geographical location.

The apparatus may comprise means for providing presence information using a first resource periodically.

The apparatus may comprise means for receiving an indication of a resource on which broadcast information is to be received.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a fourth aspect there is provided an apparatus, said apparatus comprising means for receiving presence information from a user device operating independently of a subscriber identity module using a first resource such that the network node is aware of the presence of the user device, wherein the presence information comprises a request for broadcast content and means for providing broadcast content to the user device in response to receiving the presence information.

The apparatus may comprise means for providing an indication of the first resource to the user device.

The apparatus may comprise means for providing the broadcast content using evolved multicast broadcast multimedia service.

The apparatus may comprise means for receiving presence information using the first resource periodically.

The apparatus may comprise means for determining if presence information has been received in a first time period, and means for, if so, providing broadcast content to the user device and means for, if not, causing the providing of broadcast content to stop or releasing a resource used for broadcast content.

The apparatus may comprise means for providing an indication of a resource on which broadcast information is to be received in response to receiving the presence information.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a fifth aspect, there is provided an apparatus comprising at least one processor and at least one memory including a computer program code, the at least one memory and the computer program code configured to, with the at least one processor, cause the apparatus at least to provide, from a user device operating independently of a subscriber identity module, presence information to a network node using a first resource such that the network node is aware of the presence of the user device, wherein the presence information comprises a request for broadcast content and receive broadcast content from the network node in response to providing the presence information.

The apparatus may be configured to receive a broadcast of an indication of the first resource from the network node.

The apparatus may be configured to receive the broadcast content using evolved multicast broadcast multimedia service.

The apparatus may be configured to determine a geographical location of the user device and determine to provide presence information using the first resource in dependence on the determined geographical location.

The apparatus may be configured to provide presence information using the first resource periodically.

The apparatus may be configured to receive an indication of a resource on which broadcast information is to be received.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a sixth aspect, there is provided an apparatus comprising at least one processor and at least one memory including a computer program code, the at least one memory and the computer program code configured to, with the at least one processor, cause the apparatus at least to receive presence information from a user device operating independently of a subscriber identity module, using a first resource such that the network node is aware of the presence of the user device, wherein the presence information comprises a request for broadcast content and provide broadcast content to the user device in response to receiving the presence information.

The apparatus may be configured to provide an indication of the first resource to the user device.

The apparatus may be configured to provide the broadcast content using evolved multicast broadcast multimedia service.

The apparatus may be configured to receive presence information using the first resource periodically.

The apparatus may be configured to determine if presence information has been received in a first time period, and if so, provide broadcast content to the user device and, if not, causing the providing of broadcast content to stop or releasing a resource used for broadcast content.

The apparatus may be configured to provide an indication of a resource on which broadcast information is to be received in response to receiving the presence information.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a seventh aspect, there is provided a computer program embodied on a non-transitory computer-readable storage medium, the computer program comprising program code for controlling a process to execute a process, the process comprising providing, from a user device operating independently of a subscriber identity module, presence information to a network node using a first resource such that the network node is aware of the presence of the user device, wherein the presence information comprises a request for broadcast content and receiving broadcast content from the network node in response to providing the presence information.

The process may comprise receiving a broadcast of an indication of the first resource from the network node.

The process may comprise receiving the broadcast content using evolved multicast broadcast multimedia service.

The process may comprise determining a geographical location of the user device and determining to provide presence information using the first resource in dependence on the determined geographical location.

The process may comprise providing presence information using the first resource periodically.

The process may comprise receiving an indication of a resource on which broadcast information is to be received.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In an eighth aspect there is provided a computer program embodied on a non-transitory computer-readable storage medium, the computer program comprising program code for controlling a process to execute a process, the process comprising receiving presence information from a user device operating independently of a subscriber identity module using a first resource such that the network node is aware of the presence of the user device, wherein the presence information comprises a request for broadcast content and providing broadcast content to the user device in response to receiving the presence information.

The process may comprise providing an indication of the first resource to the user device.

The process may comprise providing the broadcast content using evolved multicast broadcast multimedia service.

The process may comprise receiving presence information using the first resource periodically.

The process may comprise determining if presence information has been received in a first time period, and if so, providing broadcast content to the user device and, if not, causing the providing of broadcast content to stop or releasing a resource used for broadcast content.

The process may comprise providing an indication of the resource on which broadcast information is to be received in response to receiving the presence information.

The first resource may comprise at least one of a temporal resource, a code resource and a frequency resource.

The first resource may comprise a code resource and the presence information may comprise at least one preamble sequence reserved from a plurality of preamble sequences.

The plurality of preamble sequences may be a plurality of random access preamble sequences.

The first resource may comprise at least one of the temporal resource and the frequency resource and the presence information may comprise a signal sent on the first resource.

The first resource may be predefined at the user device and the network node.

The resource on which broadcast information is to be received may be predefined at the user device.

In a ninth aspect there is provided a computer program product for a computer, comprising software code portions for performing the steps the method of the first and second aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a flowchart of an example random access procedure between a UE and an eNB;

FIG. 4 shows a flowchart of a method according to some embodiments;

FIG. 5 shows a flowchart of a method according to some embodiments;

FIG. 6 shows a schematic diagram of an example control apparatus

### DESCRIPTION OF EMBODIMENTS

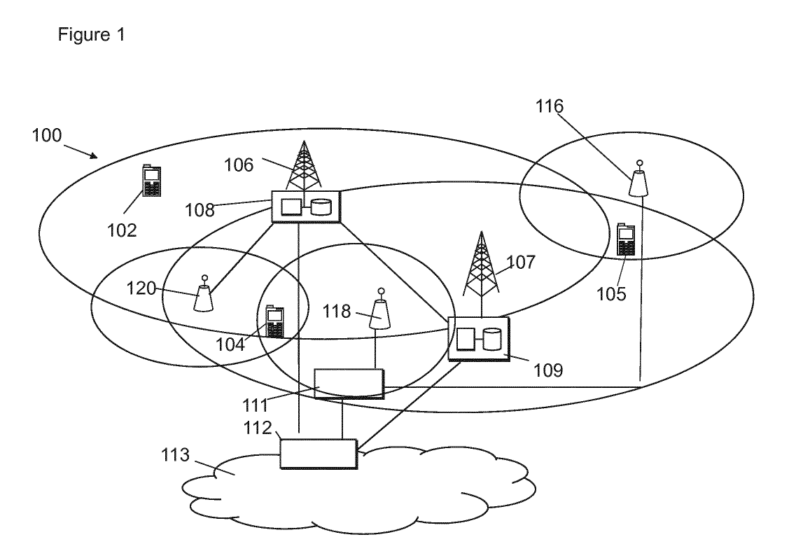

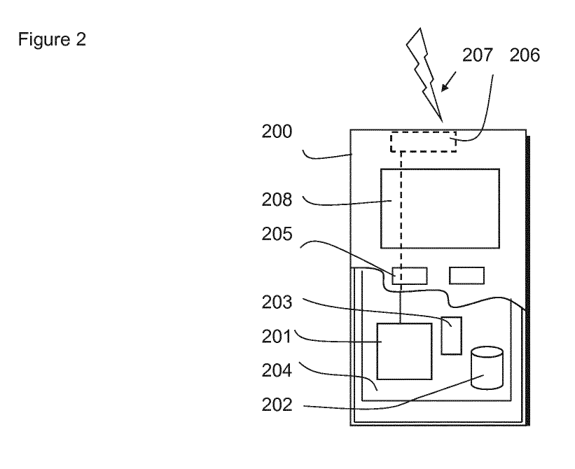

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. A base station is referred to as an eNodeB B (eNB) in LTE. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. Other examples of radio access system comprise those provided by base stations of systems that are based on technologies such as wireless local area network (WLAN) and/or WiMAX (Worldwide Interoperability for Microwave Access). A base station can provide coverage for an entire cell or similar radio service area.

Currently there are discussions about the possibility of delivering linear and non-linear broadcast services via mobile broadband networks such as, for example, LTE networks and/or future 5G networks. For example, the European Broadcasting Union (EBU) Strategic Programme on Cooperative Terrestrial Networks (CTN) has established a Project Group CTN-Mobile with the purpose of assessing the potential to support broadcasting service over broadband networks. The main outcome of the project relates to the delivery of broadcast content and service over LTE networks, more specifically via LTE evolved multicast broadcast multi-media service (eMBMS). Different deployment scenarios are also discussed.

Depending on jurisdiction, broadcasters may be subject to regulations and/or obligations, which may also be applicable when broadcast services are delivered to mobile terminals using mobile broadband networks. When providing delivery of broadcast service over mobile networks, these obligations and regulations may need to be taken into account.

For example, one general requirement (which reflects the basic principles which determine the business model of Public Service Media) is the possibility for free-to-air, or equivalent, content, with no additional cost for the users, that is, viewers and listeners. In the context of audio visual content over IMT (international mobile telecommunications), this requirement may be satisfied by unencrypted content delivered via LTE evolved multicast broadcast multi-media service (eMBMS). eMBMS can be received without a SIM card, as opposed to delivery via LTE unicast, where a SIM card may be needed.

One way of broadcasting content towards UEs without a SIM card may involve content being delivered by broadcast, regardless of whether the UE is interested or not. With regular LTE operation, it is always assumed that the UEs have a SIM card and are connected to a network (NW) in one way or another. UEs operating with a SIM card and connected to a NW can request the consumption of the broadcast service. However, how UEs without a SIM can request consumption of broadcast content and how a NW knows whether there are UEs without SIM card listening to a broadcast service has not been determined. Without such information, NW may blindly broadcast all relevant information. This may significantly reduce the efficiency of resource usage. It may be desirable to provide efficient radio resource usage, while at the same time meeting the requirements from regulation bodies. To be more specific, it may be desirable to improve the support of broadcast service for UEs without SIM cards or operating independently of a SIM. In the following, a UE without a SIM card refers to a UE operating independently of a SIM, e.g. a UE with no SIM physically present, a UE with an unactivated SIM or a UE which can switch between operating modes, where in one of said operating modes the UE can operate independently of a SIM.

Currently, a UE without a SIM card may only have limited service, for example, making emergency calls, receiving emergency messages, etc. Supporting general broadcast service for UEs without SIM card has not been considered. One solution is that a network (NW) would always broadcast the content whether or not there is a receiver. In this case, a UE (without a SIM card) will synchronize to the NW, by reading system information block (SIB) for example where an eNB may indicate the resource used for information broadcast, transmission format etc., if these resources are not pre-configured at the UE. Based on information from the SIB, a UE can detect the broadcast information.

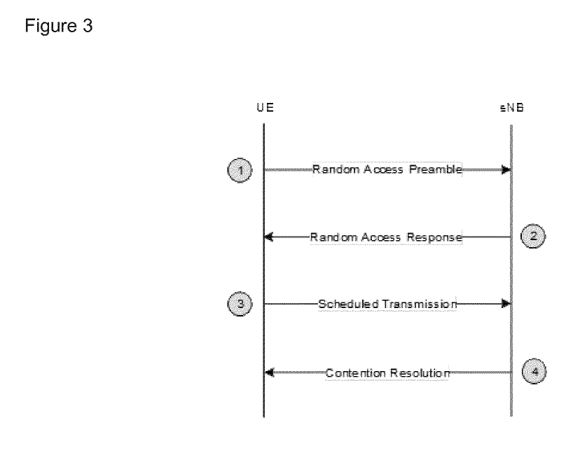

FIG. 3 shows a flowchart of a random access procedure where a UE sends a random access preamble to an eNB and the eNB prepares a random access response message to send to the UE and allocates resource to the UE in response to receiving a random access preamble from the UE.

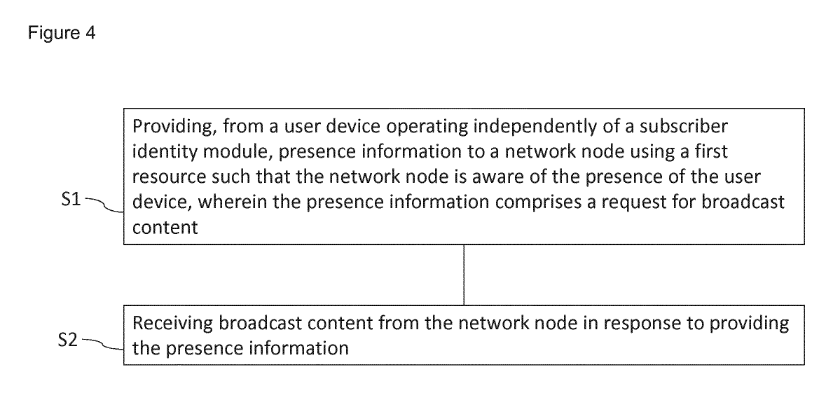

FIG. 4 shows a flowchart of a method according to some embodiments. In a first step, S1, the method comprises providing, from a user device operating independently of a subscriber identity module, presence information to a network node using a first resource such that the network node is aware of the user device, wherein the presence information comprises a request for broadcast content.

In a second step, S2, the method comprises receiving broadcast content from the network node in response to providing the presence information.

A method as described with reference to FIG. 4 may provide a trigger based broadcast service.

The UE operating independently of a SIM may be a UE without a SIM, requesting broadcast service.

The first resource may be a temporal resource, a frequency resource and/or a code resource. The first resource may be dedicated for use in providing presence information. In an embodiment, wherein the first resource is a code resource, the presence information may comprise at least one preamble sequence. The at least one preamble sequence may be reserved from a plurality of preamble sequences. The plurality of preamble sequences may be a plurality of random access preamble sequences. The plurality of preamble sequences other than the at least one reserved preamble sequence may be used in a random access procedure. For example one sequence from random access preamble may be configured as the presence information used to provide a broadcast service indication. At least one specific preamble sequence can be defined for this purpose. The at least one preamble sequence may be associated with a plurality of user devices. The at least one sequence may be pre-defined at the user device and network node in the specification and/or provided to UE from the network node, e.g. broadcast by the network node in system information blocks received at the UE during a network access phase. This specific sequence may be shared among all UEs without SIM which are requesting broadcast content delivery.

Alternatively, or in addition, the first resource may be a specific resource, e.g. a temporal or frequency resource, dedicated for the purpose of a UE without a SIM informing the NW that the UE is expecting a broadcast. That is, wherein the first resource comprises a frequency or temporal resource, the presence information may comprise a signal sent on the first resource. For example, a specified resource may be reserved for UE without SIM card requesting broadcast service. The specific resource may be a random access resource or independent to random access resource. For example one specific PRB(s) may be reserved for this purpose of a UE without a SIM informing the NW that the UE is expecting a broadcast. After synchronization with a NW, UE will know where this specific resource located.

Once a UE without SIM needs broadcast service and is not able to identify the broadcast content, it may send a signal using the specific resource. The signal should be known at both UE and NW side, for example the signal may be specified in standard. The signal may be a sequence such as a preamble sequence, another sequence or any other suitable format. The NW monitors the dedicated resource for such a signal. Once the signal is detected, NW may start broadcasting service.

User device identification information may be provided to the network with the presence information. In one embodiment, authentication may be needed when a UE without SIM requests broadcast service. Providing the preamble reception may not be sufficient if the preamble is not UE specific. If the preamble is not UE specific, the UE may transmit a preamble plus ID information when requesting broadcast service. The ID information may be any suitable information identifying the UE, including but not limited to IMSI, MAC address or any other format. With the help of ID information, the NW can authenticate the requesting UE.

When there is a UE without SIM within the NW and the same UE requests broadcast service, the UE will inform NW of the UE's presence by providing presence information using the first resource. This may avoid unnecessary broadcast by the NW. There is no need to have a “full” link established between the NW and the UE to provide the presence information.

In an embodiment, once a UE without SIM powers on and determines a requirement to receive broadcast content, the UE provides presence information, e.g., a specific preamble sequence, to the NW using the first resource.

After power on, a UE may carry out a normal LTE cell search procedure: e.g. synchronize to LTE NW and read system information blocks.

The eNB may broadcast information about the first resource e.g. an indication of the configured preamble sequence if not pre-specified in a specification. From system information blocks, UE may receive an indication of the first resource, e.g. random access or code resource, to use in providing the presence information. Where the presence information comprises a preamble sequence, if the specific preamble sequence is not pre-configured or defined in a specification, an indication of the specific preamble sequence information may be broadcast by the eNB as well.

A network node monitors whether there is a UE sending presence information. At NW side, once the presence information is received, the NW is aware of the presence of UEs without SIMs, but requesting broadcast service.

If the NW detects the presence information, i.e., the network node determines that it receives the presence information, the NW provides the broadcast content to the UE. Providing the broadcast content to the UE may comprise starting the broadcast service or starting to deliver the broadcast content using a broadcast method such that the UE without SIM card can decode it as well. The eNB does not need to prepare and send a response message, such as a random access response message after receiving the presence information, e.g. specific preamble.

When a UE without SIM starts to consume broadcast service, in case no broadcast content available, it may send the presence information to the NW using the first resource and keep listening to the broadcast system information blocks.

In case no broadcast content from is received from the NW, the UE may provide presence information again.

Since the content is being delivered to a cellular device, mobility support should be taken into account. In order to reduce the frequency of transmission of the presence information from UEs without SIM card, a service zone may be defined which means no action is needed when the UE is moving within the service zone. When the UE moves out of the service zone, re-transmission of the preamble sequence is needed if there is no ongoing broadcast session towards UEs without SIM card. To provide broadcast services in an environment where users can move from one place to another, certain broadcast service zones may be defined. If the UE moves within the same zone, there is no need to retransmit the specific preamble sequence. If the UE moves into a new zone, the UE may retransmit the preamble sequence to trigger the broadcast service.

The zone may be defined according to a geographical area. If the zone is defined according to geographical area, UE can rely on geographical location information to determine whether it is in the same zone or not. Such location information can be based on e.g. GPS. In an embodiment, the method may comprise determining a geographical location of the user device and determining to provide the presence information in dependence on the determined geographical location.

Alternatively, or in addition, the NW may broadcast zone ID information, similarly to tracking area ID. After reading the system information on zone ID, then the UE knows the zone information.

So that the NW knows if the UE moves out of the service zone, powers off or for some reason is no longer interested in broadcast content, the UE may transmit the presence information periodically. Within a certain time window, if the eNB cannot detect the presence information, it will assume that the UE without SIM is no longer requesting broadcast service. The UE may send this periodic information, if the zone information is not configured.

In an embodiment, UEs without SIM card may periodically send the information using the random access resources. At NW side, if no sequence is received for a certain time window, NW can assume no UE without SIM requesting broadcast service is present in the associated broadcast service zone. In this event, the NW may configure the transmission format independently of a requirement to provide broadcast content to the user device without a SIM and the NW has full freedom to configure the transmission format.

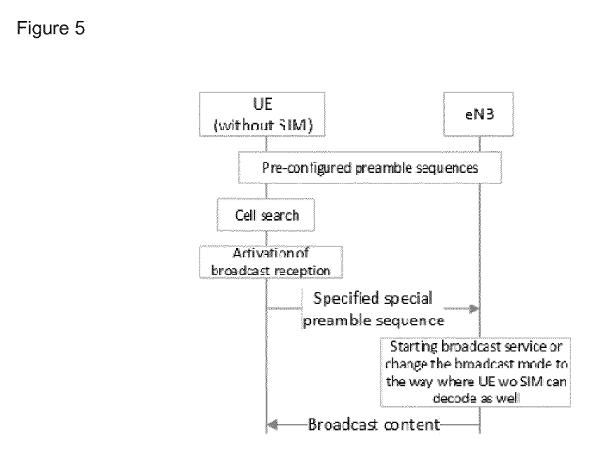

FIG. 5 shows an example random access process according to a method as discussed with reference to FIG. 4. A UE without SIM and eNB have a preconfigured preamble sequence. When the UE performs a cell search and activates broadcast reception, the UE sends the preamble sequence using the first resource. The eNB then provides broadcast content to the UE, for example by starting the broadcast service or changing the broadcast mode to one in which a UE without SIM can decode the broadcast content. In contrast with FIG. 3, the NW does not provide a response to the random access preamble. The UE does not expect any random access response from eNB as in normal random access procedure as shown in FIG. 3.

Thus, the NW may not need to allocate any UL resource other than the first resource, e.g. the random access preamble sequence since for UE without SIM, the only UL transmission is the preamble sequence. After receiving this specific random access preamble, eNB provides the broadcast service to UEs without SIM card.

A method as described with reference to FIGS. 4 and 5 may provide a way for NW to receive information about the presence of UEs without SIM cards requesting broadcast information without introducing complexity to UEs and NW implementation.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of broadcast technology, similar principles may be applied in relation to other examples of e.g., 3G, 4G LTE or 5G networks and broadcast scenarios. It should be noted that other embodiments may be based on other cellular technology other than LTE or on variants of LTE. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

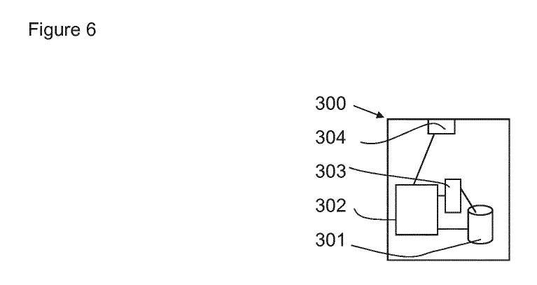

The method may be implemented in entities on a mobile device as described with respect to FIG. 2 or control apparatus as shown in FIG. 6. The method may be implanted in a single processor 201 or control apparatus or across more than one processor or control apparatus. FIG. 6 shows an example of a control apparatus for a communication system, for example to be coupled to and/or for controlling a station of an access system, such as a RAN node, e.g. a base station, (e) node B, a central unit of a cloud architecture or a node of a core network such as an MME or S-GW, a scheduling entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise providing, from a user device operating independently of a subscriber identity module, presence information to a network node using a first resource such that the network node is aware of the presence of the user device, wherein the presence information comprises a request for broadcast content and receiving broadcast content from the network node in response to providing the presence information.

Alternatively, or in addition, control functions may comprise receiving presence information from a user device operating independently of a subscriber identity module using a first resource such that the network node is aware of the presence of the user device, wherein the presence information comprises a request for broadcast content and providing broadcast content to the user device in response to receiving the presence information.

In an embodiment at least some of the functionalities of the apparatus of FIG. 6 may be shared between two physically separate devices forming one operational entity. Therefore, the apparatus may be seen to depict the operational entity comprising one or more physically separate devices for executing at least some of the described processes. The apparatus utilizing such shared architecture, may comprise a remote control unit (RCU), such as a host computer or a server computer, operatively coupled (e.g. via a wireless or wired network) to a remote radio head (RRH) located in the base station. In an embodiment, at least some of the described processes may be performed by the RCU. In an embodiment, the execution of at least some of the described processes may be shared among the RRH and the RCU.

In an embodiment, the RCU may generate a virtual network through which the RCU communicates with the RRH. In general, virtual net-working may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides net-work-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
providing, from a user device operating independently of a subscriber identity module, presence information to a network node using a first resource such that the network node is aware of the presence of the user device, wherein the presence information comprises a request for broadcast content; and
receiving broadcast content from the network node in response to providing the presence information.

2. A method according to claim 1, comprising receiving a broadcast of an indication of the first resource from the network node.

3. A method according to claim 1, comprising receiving the broadcast content using evolved multicast broadcast multimedia service.

4. A method according to claim 1, comprising determining a geographical location of the user device; and
determining to provide presence information using the first resource in dependence on the determined geographical location.

5. A method according to claim 1, comprising providing presence information using the first resource periodically.

6. A method according to claim 1, comprising receiving an indication of a resource on which broadcast information is to be received.

7. A method comprising:
receiving presence information from a user device operating independently of a subscriber identity module using a first resource such that the network node is aware of the presence of the user device, wherein the presence information comprises a request for broadcast content; and
providing broadcast content to the user device in response to receiving the presence information.

8. A method according to claim 7, comprising providing an indication of the first resource to the user device.

9. A method according to claim 7, comprising providing the broadcast content using evolved multicast broadcast multimedia service.

10. A method according to claim 7, comprising receiving presence information using the first resource periodically.

11. A method according to claim 10, comprising determining if presence information has been received in a first time period, and if so, providing broadcast content to the user device and, if not, causing the providing of broadcast content to stop or releasing a resource used for broadcast content.

12. A method according to claim 7, comprising providing an indication of a resource on which broadcast information is to be received in response to receiving the presence information.

13. A method according to claim 7, wherein the first resource comprises at least one of a temporal resource, a code resource and a frequency resource.

14. A method according to claim 13, wherein the first resource comprises a code resource and the presence information comprises at least one preamble sequence reserved from a plurality of preamble sequences.

15. A method according to claim 13, wherein the first resource comprises at least one of the temporal resource and the frequency resource and the presence information comprises a signal sent on the first resource.

16. A method according to claim 7, wherein the first resource is predefined at the user device and the network node.

17. A method according to claim 7, wherein a resource on which broadcast information is to be received is predefined at the user device.

18. (canceled)

19. A computer program product for a computer, comprising software code portions for performing the steps of claim 1 when the product is run on the computer.

20. An apparatus comprising:
at least one processor and at least one memory including a computer program code, the at least one memory and the computer program code configured to, with the at least one processor, cause the apparatus at least to:
provide, from a user device operating independently of a subscriber identity module, presence information to a network node using a first resource such that the network node is aware of the presence of the user device, wherein the presence information comprises a request for broadcast content; and
receive broadcast content from the network node in response to providing the presence information.

21. An apparatus comprising:
at least one processor and at least one memory including a computer program code, the at least one memory and the computer program code configured to, with the at least one processor, cause the apparatus at least to:
receive presence information from a user device operating independently of a subscriber identity module, using a first resource such that the network node is aware of the presence of the user device, wherein the presence information comprises a request for broadcast content; and
provide broadcast content to the user device in response to receiving the presence information.
